(19) United States
(12) Patent Application Publication
(10) Pub. No.: US 2003/0016103 A1
(43) Pub. Date: Jan. 23, 2003

(54) Multi-pole contactor-circuit breaker type switch

(75) Inventors: Jean Haudry, Vernouilet (FR); Philippe Guibert, Chatou (FR)

Correspondence Address: PARKHURST & WENDEL, L.L.P., 1421 PRINCE STREET, SUITE 210, ALEXANDRIA, VA, 22314-2805, US

(73) Assignee: Schneider Electric Industries SAS, Rueil-Malmaison (FR)

(21) Appl. No.: 10/197,576

(22) Filed: Jul. 18, 2002

(30) Foreign Application Priority Data
Jul. 18, 2001 (FR) 01 09 638

(51) Int. Cl. H01H 75/00

(52) U.S. Cl. 335/9

(57) ABSTRACT

This invention relates to a multi-pole contactor-circuit breaker type switch composed of a housing (1) containing breaking poles (11) activated by a control electromagnet (16) and by a trip control mechanism (18, 14) and comprising a protection module (2) equipped with means (21) for measuring pole currents and means (22) for acting on the electromagnet (16) and on the trip control mechanism (14) if a fault current is detected, characterised by the fact that it comprises a control and/or communication module (3) that is installed removably on the housing, below the protection module (2) and communicating with the processing circuit (22) on the said protection module (2) through connectors (23, 33).

This invention relates to a multi-pole contactor-circuit breaker type switch composed of a housing containing breaking poles activated by a control electromagnet and by a trip control mechanism and comprising a protection module equipped with means for measuring pole currents and means for acting on the electromagnet and on the trip control mechanism if a fault current is detected.

A contactor-circuit breaker tests the current passing in current lines (“contactor” function) and provides protection (“circuit breaker” function) when an electrical fault appears on at least one of the lines (for example in the case of a short circuit), by means of breaking poles activated by an electromagnet. When an electrical fault occurs, a protection device with an electromagnetic trip acts on the poles. This device may be reset by a manual control device which also opens and closes the contacts.

The purpose of the invention is to supply a switch in which the electronic protection device cooperates with a removable module providing interface and connection functions with other equipment.

According to the invention, the switch comprises a control and/or communication module that is installed removably on the housing below the protection module and communicating with the processing circuit on the said protection module through connectors.

According to one specific feature, the control and/or communication module comprises state switches at the back mechanically actuated by the said control mechanism and/or the pole control electromagnet, in order to provide state information about the poles and/or the trip mechanism.

The invention will now be described in more detail with reference to embodiments given as examples and represented by the appended drawings in which:

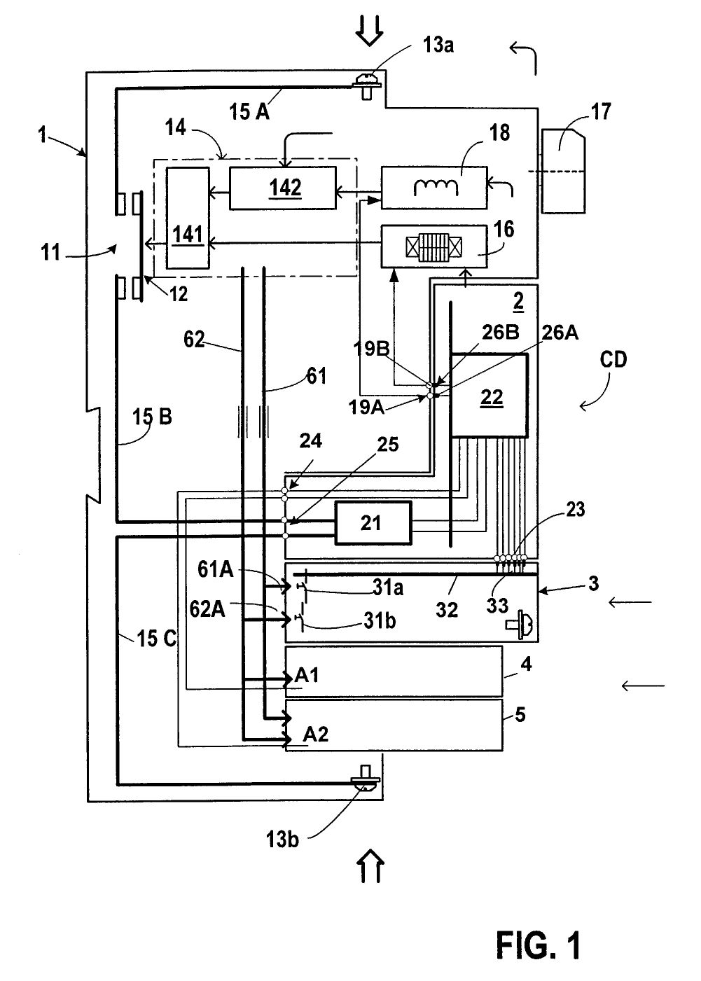

FIG. 1 is a diagram showing a side view of a contactor-circuit breaker conform with the invention;

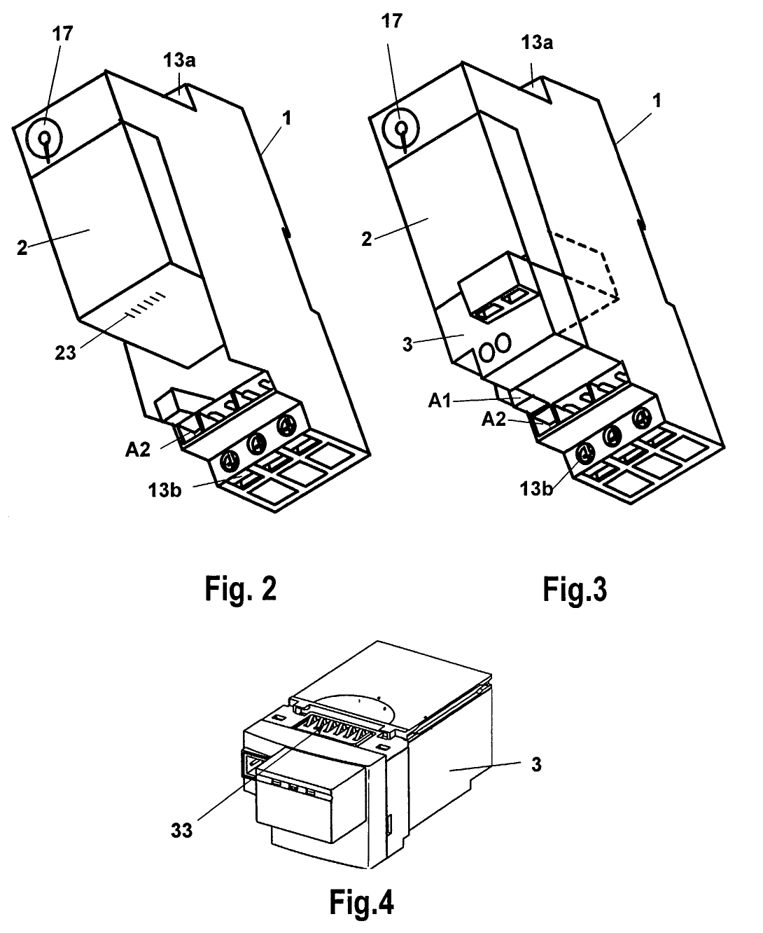

FIG. 2 is a perspective view of the contactor-circuit breaker on which the control or communication module has been removed;

FIG. 3 is a perspective view of the contactor-circuit breaker on which the control or communication module is installed;

FIG. 4 is a perspective view of a control and communication module;

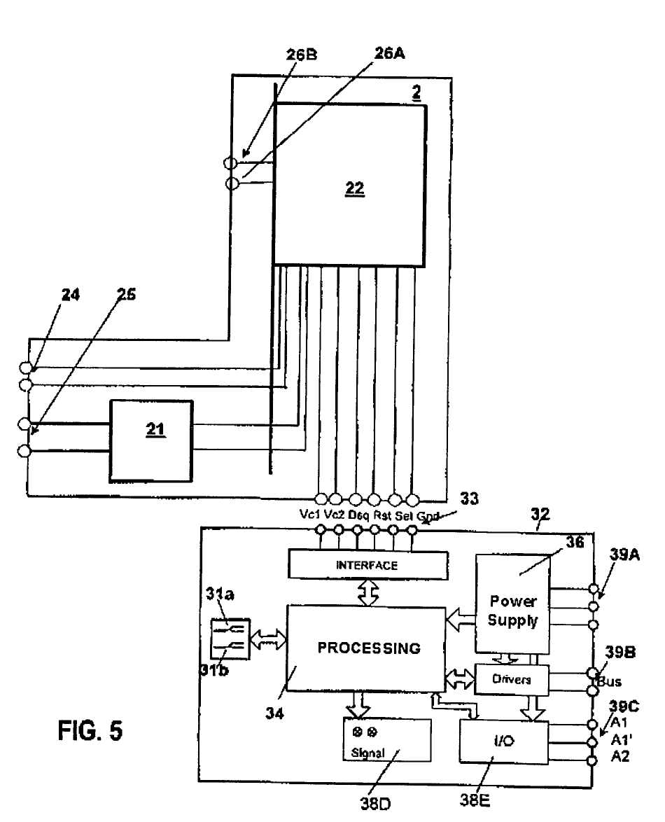

FIG. 5 is a functional diagram of a module performing a communication function and the associated protection module;

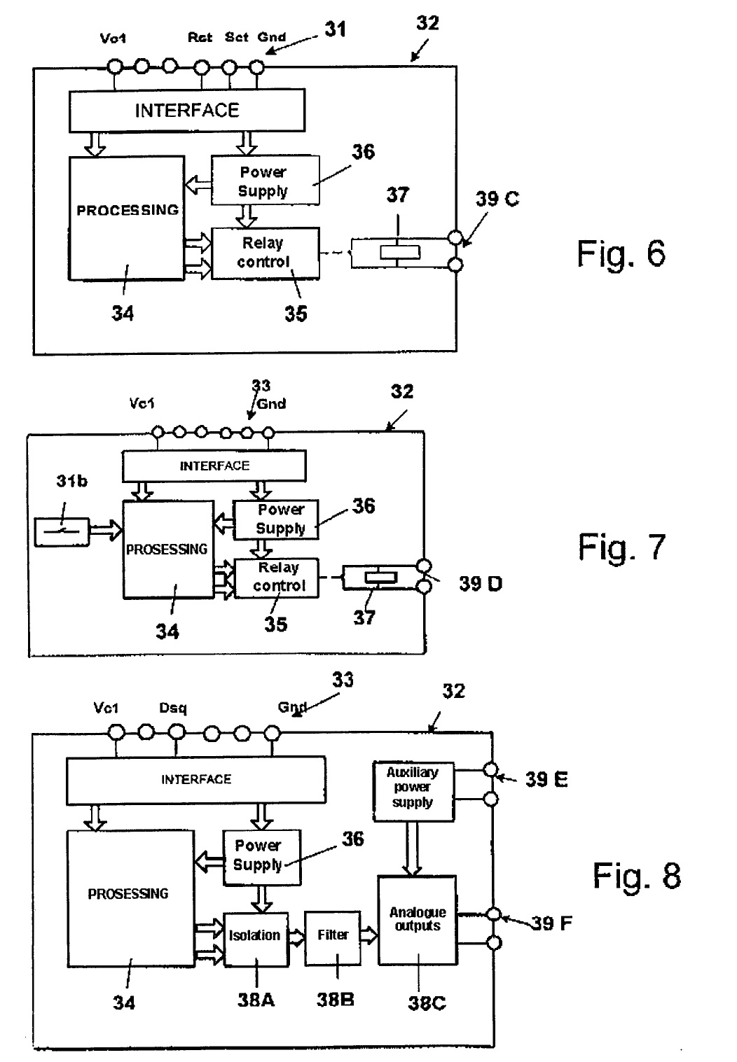

FIG. 6 is a functional diagram of a module performing a pre-alarm function or a fault management function;

FIG. 7 is a functional diagram of a module performing a timed auxiliary contacts function;

FIG. 8 is a functional diagram of a module performing a motor load display function.

The contactor-circuit breaker reference CD as illustrated in FIG. 1 comprises a housing 1 containing chambers and breaking poles, and a control part in contactor mode.

The housing 1 comprises a pole 11 with separable contacts 12 and preferably with double break (single break as a variant), on each power current line 15. A single pole is shown in FIG. 1, but the switch is multi-pole.

Each power current line 15 will be connected to a power supply on the input side and to a load on the output side. Power terminal blocks 13a, 13b are located near the top and bottom of housing 1 for connections to the power lines (according to the arrows shown).

The mobile contacts 12 of the poles 11 are actuated by the control part in contactor mode, under the control of the power supply to an electromagnet 16.

A mechanical subassembly 14 acts on the contacts 12, to open and close them. This subassembly 14 is housed in the housing 1 and comprises a mechanism 141 on which the electromagnet 16 acts, and a mechanism 142 with which a manually controlled button 17 and a trip device 18 cooperate, and this trip device itself cooperates with the mechanism 141, and mechanisms 141 and 142 may have some common parts.

The mobile contacts of poles 11 may be controlled by the manual control button 17 placed on the front of the switch. It is used to open the poles manually and to reset the device after tripping.

The mechanism 142 entrains a mobile part 61, preferably consisting of a rod and intended to actuate the first auxiliary contacts. The rod 61 can be moved in translation to take up three positions; an On position, an Off position and a tripped position, depending on the state of the mechanism 14, to represent the On (ready) state of the device, or its Off state or its Tripped state. It has actuators such as 61A, and the position of the actuators represents the state (On-Off-Tripped) of the control mechanism 14.

The electromagnet 16 entrains a mobile part 62 preferably composed of a rod and intended to actuate the second auxiliary contacts. The rod 62 can be moved in translation from a working position to a rest position and vice versa in response to the electromagnet 16 being switched. It has actuators such as 62A used to control the contacts.

These rods 61 and 62 are guided in the housing 1 to slide along their length (parallel to the power lines as shown in FIG. 1).

The control part is associated with an electronic protection and control module 2 which, in a preferred embodiment, is removably connected to housing 1 containing the control part. This protection and control module 2 is located below the part housing the electromagnet, the trip device and the mechanical subassembly.

The protection and control module 2 is L-shaped, and one of the arms of the L houses the current sensors 21 and the other houses the electronics. It has connectors 26 on the side opposite the visible face that cooperate with the connectors 19 to make the electronic circuit 22 of the protection module communicate with the electromagnet 16 and the trip mechanism 18. The protection module 2 performs a protection function and outputs a fault signal to the trip device 18 when a fault (short circuit) current is detected by the said sensor, the trip device 18 then controlling opening of the contacts 12.

The protection and control module 2 houses the current sensors 21 that will detect a current passing in a pole. Each of the sensors 21 is connected through connectors 25 to power line segments 15B and 15C that are located on the output side of the pole 11, the power line being completed by a segment 15A on the input side of the pole. Each sensor 21 of the module 2 is connected through its outputs to an electronic protection circuit 22 that is connected to the electromagnet coil 16 by connectors 26B-19B and to the electromagnetic trip device through connectors 26A-19A.

The electronic protection circuit 22 also receives a power supply voltage from the power supply terminals A1 and A2 laid out visibly on the front of the housing near the bottom. These terminals are connected to conductors that are housed in the housing and are connected through connectors 24 to conductors in the protection module 2 leading to pins on the electronic circuit 22. This power supply voltage applied to terminals A1 and A2 is used to power the protection module, the trip device and the coil. The power supply connectors 24 are located close to the power connectors 25 connecting the current sensors 21 to the power conductors 15.

Below the protection module 2, the switch is provided with a space used to house a removable control or communication module 3 in the form of a cassette.

Some modules 3 are provided with mechanical or electronic contacts or switches 31a and 31b near the back, that are manoeuvred by actuators 61A and 62A.

On the side adjacent to module 3, the protection module 2 is fitted with a connector 23 which has several pins, the function of which will be described below, and that match a connector 33 of module 3 when module 3 is put into place below the protection module 2.

Connector 23-33 enables information exchanges between module 3 and the protection circuit 22 of the protection module 2. This connector 23-33 has 6 pins that are connected to pins Vc1, Vc2, Dsq, Rst, Set, Gnd of the electronic circuit 22.

The output pin Vc1 of the circuit 22 on which a capacitor is wired outputs a positive voltage to the coil of the control electromagnet 16.

The output pin Vc2 of circuit 22 on which a capacitor is wired outputs a positive voltage that activates the trip device 18.

Pin Dsq of circuit 22 outputs a voltage that is an instantaneous image of the ratio Im/Ir, where Im is the current circulating in the power conductors 15, Ir is the nominal device usage current that is displayed on the front of the protection module 2 and that the customer can adjust.

The output pin Rst of the circuit 22 outputs a “reset” order.

The output pin Set of the circuit 22 outputs several signals from the protection circuit 22 that represent faults, namely the prealarm, magnetic fault, temperature fault, internal fault, etc.

The Gnd pin in circuit 22 is the ground, which is the common reference point between the protection module 2 and the communication module 3.

The communication module 3, for which the electronic diagram is illustrated in FIG. 5, is fitted with the protection module 2 and receives the various signals Vc1, Vc2, Dsq, Rst, Set, Gnd. These signals are sent through an interface to a processing circuit 34 that also receives state information about the contacts 31a and 31b and is powered from an external connector 39A. This processing circuit 34 exchanges information through the connector 39B for the communication bus (field bus) and controls terminals A1, A′1, A2 of a connector 39C, through an input-output circuit 38E. Terminals A1 and A2 are directly connected to terminals A1 and A2 of the basic product or an associated inverter module, through a pre-wiring subassembly.

Module 3, for which the electronic diagram is illustrated in FIG. 6, performs a prealarm or fault management function. It receives the Vc1 and Gnd signals that are sent through an interface to a processing circuit 34 powered by Vc1 and Gnd and a power supply circuit 36. This processing circuit 34 controls a relay output 39C on the front of the module, through a control circuit 35 and a relay 37. The relay output indicates that a given temperature state is exceeded or a fault (short circuit, temperature fault, etc.).

Module 3 with timed signal auxiliary contacts, for which the electronic diagram is illustrated in FIG. 7, receives the Vc1 and Gnd signals that are sent through an interface to a processing circuit powered by Vc1 and Gnd and a power supply circuit 36. This processing circuit 34 also receives information about the state of the contact 31b activated by the actuator representing the state of the poles. This processing circuit 34 controls a relay output 39d through a control circuit 35 and a relay 37. The relay output 39D represents the open or closed state of the electromagnet and therefore poles with a time-out.

Module 3 with display of the motor load for which the electronic diagram is shown in FIG. 8, receives the Vc1, Dsq and Gnd signals that are sent through an interface to a processing circuit 34 powered by Vc1 and Gnd and a power supply circuit 36. The processing circuit 34 outputs analogue information that can be used for example to control a display or to provide information about the motor load to a controller, through a circuit 38A, a filter 38B and a circuit with analogue outputs 38C, on an output 39F. A connector 39E can be provided for an auxiliary power supply.

A slot is provided below module 3 in which a module 4 can be placed, and a second slot is provided in which a module 5 can be fitted. The module 3 may be sufficiently high to cover the housing of the module dedicated to fault functions and located below it.

Obviously, it will be possible to imagine variants and improvements to detail and even to consider the use of equivalent means, without departing from the scope of the invention.

1. Multi-pole contactor-circuit breaker type switch composed of a housing (1) housing breaking poles (11) activated by a control electromagnet (16) and by a trip mechanism (18, 14) and comprising a protection module (2) equipped with means (21) of measuring the pole currents and means (22) of controlling the electromagnet (16) and the trip control mechanism (14) if a fault current is detected, characterized by the fact that it comprises a control and/or communication module (3) fixed removably on the housing below the protection module (2), and communicating through connectors (23, 33) with the processing circuit (22) of the said protection module (2).

2. Switch according to claim 1, characterized by the fact that the control and/or communication module (3) has state switches (31a, 31b) at the back, mechanically activated by the said control mechanism and/or the pole control electromagnet to provide state information about the poles and/or the trip mechanism.

3. Switch according to claim 1 or 2, characterized by the fact that the protection module (2) is L-shaped, that one of the arms of the L houses the current sensors (21) and the other arm houses an electronic circuit (22) and is fitted with connectors (26) on the side opposite the visible face, that make the said electronic circuit (22) communicate with the electromagnet (16) and the trip mechanism (18).

4. Switch according to any one of the previous claims, characterized by the fact that it comprises test power supply terminals (A1, A2) being prolonged by conductors housed in the housing, which are connected through power supply connectors (24) to the electronic circuit (22) of the protection module.

5. Switch according to any one of the previous claims, characterized by the fact that the power supply connectors (24) are located close to the power connectors (25) connecting the current sensors (21) to the power conductors (15).

6. Switch according to any one of the previous claims, characterized by the fact that the control and/or communication module (3) communicates with at least one output ( Vc1, Vc2) from the electronic circuit (22) of the protection module on which a capacitor is wired and outputs a positive voltage.

7. Switch according to any one of the previous claims, characterized by the fact that the control and/or communication module (3) communicates with at least one output (Dsq) from the electronic circuit (22) of the protection module outputting a voltage that is an instantaneous image of the ratio (lm/lr) of the current circulating in the power conductors to the nominal usage current.

8. Switch according to any one of the previous claims, characterized by the fact that the control and/or communication module (3) communicates with at least one output (Set) of the electronic circuit (22) of the protection module outputting several signals that represent faults.

9. Switch according to any one of the previous claims, characterized by the fact that the control and/or communication module (3) communicates with at least one output (Rst) of the electronic circuit (22) of the protection module that outputs a “reset” order and an output (Gnd) from the same circuit (22) forming the ground.

10. Switch according to any one of the previous claims, characterized by the fact that the control and/or communication module (3) comprises a processing circuit (34) into which information from the electronic circuit (22) of the protection module is input, and controlling at least one output (39) or signal means on the front face.

11. Switch according to claim 10, characterized by the fact that the processing circuit (34) receives information originating from state switches (31a , 31b ).
